(19) United States
(12) Patent Application Publication
(10) Pub. No.: US 2002/0107939 A1
(43) Pub. Date: Aug. 8, 2002

(54) System and method for accessing software components in a distributed network environment

(76) Inventors: Daniel E. Ford, Granite Bay, CA (US); Eric Hubbard, Roseville, CA (US)

Correspondence Address: HEWLETT-PACKARD COMPANY, Intellectual Property Administration, P.O. Box 272400, Fort Collins, CO, 80527-2400, US

(21) Appl. No.: 09/779,390

(22) Filed: Feb. 7, 2001

(51) Int. Cl. G06F 15/16

(52) U.S. Cl. 709/218; 709/219

(57) ABSTRACT

A system and method are described that are described for accessing software components, interfaces, or resources in a distributed network environment. A distinctive feature of the system and method described herein is the ability to locate such components, interfaces, or resources based upon certain specified attributes, and without having prior knowledge of the address or location of the component, interface, or resource. In accordance with one embodiment, a method includes the steps of generating a request for a component having a least one specified attribute, broadcasting the request across the network, receiving the request at a service provider, comparing the at least one specified attribute of the received request with component attributes of the service provider, and communicating a response to the requesting service consumer. The system includes mechanisms for implementing and carrying out these steps.

### BACKGROUND OF THE INVENTION

1. Field of the Invention

The present invention relates to networked computer systems and, more particularly, to a novel system and method for accessing software components (for cohesive execution) that are located across a distributed network environment.

2. Discussion of the Related Art

Broadly stated, software applications in a distributed (networked) environment may be thought of as service providers, service consumers, or both. As the names imply, service providers are programs that provide interfaces, components, or resources to other programs, so that the other programs may use the interfaces, components, or resources to accomplish some task. Service consumers are programs that use the interfaces, components, or resources provided by service providers.

As is known, many software applications are “distributed” throughout a network, such that they accomplish their objectives by utilizing software components that are distributed throughout the network. The term “components,” as used herein, is intended to encompass a very broad interpretation, which includes services, interfaces, resources, code segments, etc. One example of such a distributed application is the use of network printer. Specifically, a network printer may operate under the direct control of a server that is configured to control the operation of the printer. Nevertheless, distributed applications (clients) may access and use the printer for “print” applications. Another example of such a distributed application is a GUI (graphical user interface) front end to a database (i.e., the GUI front end being an application or component associated with a computer that hosts the database). As is known, such a GUI front end may be provided to provide a certain graphical/visual “appearance” to the contents of the database. Remote software applications that seek to access the database may utilize the GUI front end.

As is known, in applications such as these, the service consumers (i.e., the software applications that seeks to use the printer or GUI front end) need to know the network address or location of the component to be provided. That is, the workstation application seeking to print needs to know the network address of the printer. Likewise, the program seeking to utilize the GUI front end needs to be configured to know the location of the computer hosting the database.

Often such components are sought based upon “attributes” that are specified by the service consumer. For example, in a corporate LAN environment, a user at a workstation may desire to print a document on a “color” printer, located on the “second” floor, of building “G”. The items in quotations (i.e., color, second, and G) are attributes that may be used to specify the printer resource desired. It is therefore desired that a system be able to take attributes like these and locate corresponding components on a network that match (or at least closely match) the specified attributes.

Various systems and methodologies are known for carrying out this broad function. These various systems and methods generally operate by utilizing a prior knowledge of the address or location of the component needed from a service provider. One approach, known as CORBA (common object request brokering architecture) utilizes an object request broker (ORB) to handle object calls between a service consumer (e.g., client) and a service provider (e.g., server). In operation, a service consumer send requests (requests for components) to the ORB. Independently, service providers “register” in with the ORB, to instruct the ORB as to the components that they can provide. The ORB, then, performs a “brokering” task, which matches requests by service consumers with capabilities of registered service providers. If no such match is found, then the ORB may so inform the service consumer. If, however, a match is found, then the ORB may inform the service consumer (and/or the service provider), so that the requested component may be delivered to the service consumer. The details as to how this brokering is specifically implemented may vary from system to system, but is generally known and understood by persons skilled in the art. Therefore, it need not be further described herein.

Another methodology that is known for carrying out this functionality involves the use of a directory service. Indeed, electronic directories are fast becoming a popular tool for managing network resources. Printed directories may comprise lists of identifying information that allow service consumers to find and easily access components. Among other information, these directories usually contain the network address or location for the component listed therein.

Early electronic directories were typically developed for a particular application and computer system, and were therefore often incompatible with other applications and systems. Protocols have emerged, however, that make it possible for almost any application running on virtually any computer system to obtain directory information. The X.500 directory access protocol (DAP), for example, provides standardized functionality that assists users in browsing or searching directories regardless of the type of server hosting the directory. Another example of a directory protocol is the Lightweight Directory Access Protocol (LDAP), a TCP/IP-based version of X.500 DAP.

Reference is made briefly to FIG. 1, which is a diagram that broadly illustrates the salient features of these types of prior art systems. FIG. 1 broadly illustrates a service consumer 10, a service provider 12, and a lookup service 14. The lookup service may either be an electronic directory, or may be the ORB within a CORBA system. In either system, the lookup service 14 is provided in a known location, so that the service provider 12 may provide the lookup service 14 with an identification of the components of the service provider 12. As a service consumer 10 needs or desires such components, it issues a request to the lookup service 14 to determine whether any such components are available on the network. If so, the lookup service 14 generally responds by identifying the network address or location of the service provider 12 having such components so that the service consumer 10 may thereafter interface directly with the service provider 12.

While systems such as these effectively allow a service consumer to obtain specified components from a service provider, without requiring the service consumer to have prior knowledge of the network address or location of the service provider, there are a number of shortcomings manifest in such systems. Significantly, the lookup service 14 represents a single point of failure within the system. Thus, although both the service provider 12 and service consumer 10 may be functioning properly, the service consumer 10 may not be able to complete its task if the lookup service 14 fails.

In addition, the lookup service 14 in such systems also represents a performance bottleneck, and slows down the access to components provided by service provider 12. Since many services may be registered with the lookup service, requests for services must generally be matched against the entire list of registered services. During the time while these comparisons are being made, both the service consumer and service provider often remain idle and unable to do any useful work.

Further still, the lookup service 14 represents a security risk, because it publishes to the world all the services registered with it. The lookup service 14 is truly an advertising service. However, there may be services that do not wish to advertise their existence to the “world” at large, but which still want to provide their services to a select few consumers. Although service providers can be configured to refuse service to consumers outside their select group, this adds an additional layer of required complexity to the service provider. Moreover, the mere existence of the service may invite unwanted attacks.

Accordingly, it is desired to provide an improved system and method for locating and associating remote software components that are dispersed across a distributed network environment, based upon specified attributes, and without requiring a prior knowledge of the address or location of the component.

### SUMMARY OF THE INVENTION

Certain objects, advantages and novel features of the invention will be set forth in part in the description that follows and in part will become apparent to those skilled in the art upon examination of the following or may be learned with the practice of the invention. The objects and advantages of the invention may be realized and obtained by means of the instrumentalities and combinations particularly pointed out in the appended claims.

The present invention is broadly directed to a system and method for accessing software components, interfaces, or resources in a distributed network environment. A distinctive feature of the invention is its ability to locate such components, interfaces, or resources based upon certain specified attributes, and without having prior knowledge of the address or location of the component, interface, or resource.

In accordance with one embodiment, a method includes the steps of generating a request for a component having a least one specified attribute, broadcasting the request across the network, receiving the request at a service provider, comparing the at least one specified attribute of the received request with component attributes of the service provider, and communicating a response to the requesting service consumer.

### DESCRIPTION OF THE DRAWINGS

The accompanying drawings incorporated in and forming a part of the specification, illustrate several aspects of the present invention, and together with the description serve to explain the principles of the invention. In the drawings:

FIG. 1 is a high-level diagram illustrating the manner in which prior art systems dynamically located software components in a computer network.

FIG. 2 is a diagram of an illustrative network environment over which a system, constructed in accordance with the present invention, may operate.

FIGS. 3A and 3B collectively comprise a diagram illustrating the principal components of a system constructed in accordance with the preferred embodiment of the invention.

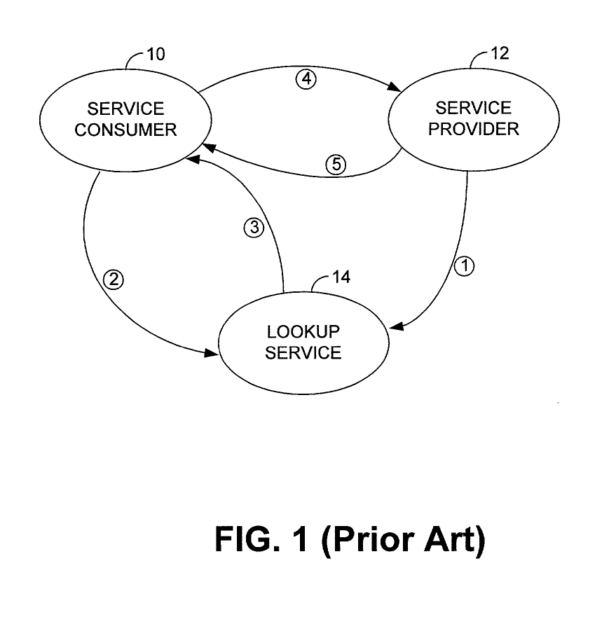

Reference will now be made in detail to the description of the invention as illustrated by the drawings. While the invention will be described in connection with these drawings, there is no intent to limit it to the embodiment or embodiments disclosed therein. On the contrary, the intent is to cover all alternatives, modifications and equivalents included within the spirit and scope of the invention as defined by the appended claims.

### DETAILED DESCRIPTION OF THE PREFERRED EMBODIMENT

Having summarized various aspects of the present invention, reference will now be made in detail to the description of the invention as illustrated in the drawings. While the invention will be described in connection with these drawings, there is no intent to limit it to the embodiment or embodiments disclosed therein. On the contrary, the intent is to cover all alternatives, modifications and equivalents included within the spirit and scope of the invention as defined by the appended claims. The drawings have illustrated the invention in the context of a graphics processing system. It will be appreciated by persons skilled in the art with reference to the discussion herein that the invention is not limited to graphics systems, but rather is extensible to other types of processing systems as well.

Definitions

Before describing the preferred embodiment of the present invention, several definitions are set out immediately below. To the extent that these terms may have a particular meaning, as a term or art or otherwise, that differs from the definitions set out below, the definitions shall control the interpretation and meaning of the terms as used within the specification and claims herein, unless the specification or claims expressly assigns a differing or more limited meaning to a term in a particular location or for a particular application.

Service Provider, as used herein, refers to an entity on a computer network that supplies a program, interface, service, or other component to a requesting device or process.

Service Consumer, as used herein, refers to an entity on a computer network that uses a program, interface, service, or like component supplied from a service provider to perform a task or otherwise get something done.

Service Descriptor, as used herein, refers to an object, table, or other device that describes or defines a service by using one or more attributes.

Service Finder, as used herein, refers to an instance of an object, or a separate process, created or used by a service consumer to control the discovery of one or more components (as defined by a service descriptor) of a service provider on a network. The service finder may also control the reporting of the discovered components to the service consumer.

Although the invention has been summarized above, before referencing the drawings, the following example is presented to help illustrate the advancement of the present invention. In this regard, an example of the network printer and a print application has been chosen merely to illustrate certain inventive concepts of the present invention. It should be appreciated, however, that the present invention has exceedingly broad ranging applications, and should in no way be limited to a printer or print application has discussed herein.

The use of network printers and print applications are well-known. In a network environment, there are often several printers available on the network. From a user perspective, in a given application (for example a Windows application) a user may typically select one of a number of available printers for which the application may print to. Prior to that, however, the computer system that the user is using is “configured.” During the configuration, the computer is instructed as to the printers that are available to it, as well as the location of each of those printers on the network. In addition, drivers are installed on the computer for each of the available printers. Once a particular printer is selected, and a command is issued to print at the selected printer, the printer driver installed on the user's computer cooperates with a driver running on a print server (e.g., the computer or process that controls the network printer) to print the job or materials selected to be printed.

The present invention, however, provides an entirely new approach to printing (in this context) as well as countless other applications. In this regard, a system configured in accordance with the present invention need not pre-configure computer workstations with printer drivers or identities. Instead, network printers may be “discovered” in real-time, and may be utilized without having to preinstall drivers on the computer workstations. The inventive system operates by identifying requested components (e.g., printers) based upon attributes that are specified by a user or workstation. In keeping with the printer example, when a user desires to print material and a system constructed in accordance with the present invention, the user need only define certain attributes of a desired printer.

For example, consider a local area network of a corporate environment. A user choosing to print a job or material may designate certain attributes of a desired printer, such as that the printer be a color laser, high-speed printer, capable of printing on both sides of the paper, and located on the fourth floor of building 100. A system constructed in accordance with the invention, would then identify all such printers satisfying the request and return a listing of those printers to the user (or requesting application), which could been select a printer based upon the list return. Of course, appropriate exception handling will preferably be designed into the system. Thus, for example, if no printer was located that matched each of the specified attributes, the system may nevertheless be configured to identify close matches, and return those to the user to select from. As a part of this exception handling and general system design, the user may be prompted to select those attributes, which are most important, so that the identification and discovery process may be formulated accordingly. Further, in a preferred embodiment a common “parlance” will preferably be chosen for specifying attributes. Details such as these, however, may be left up to the application programmer, and may vary from application to application, consistent with the scope and spirit of the present invention.

It will be appreciated, however, the system constructed in accordance with the teachings broadly described above provides a tremendous advancement over prior art systems. For example, new printers may be added to the network, without requiring a technician to visit each individual workstation to install an appropriate driver for the new printer, or update the printer selection. Further, if a printer fails, or is otherwise removed from the network for a period of time, such a failure or removal would be transparent to the users, as that printer would simply not respond to a request broadcast from a given workstation requesting a printer service. Numerous other benefits and advantages will become apparent to those skilled in the art from the disclosure provided herein.

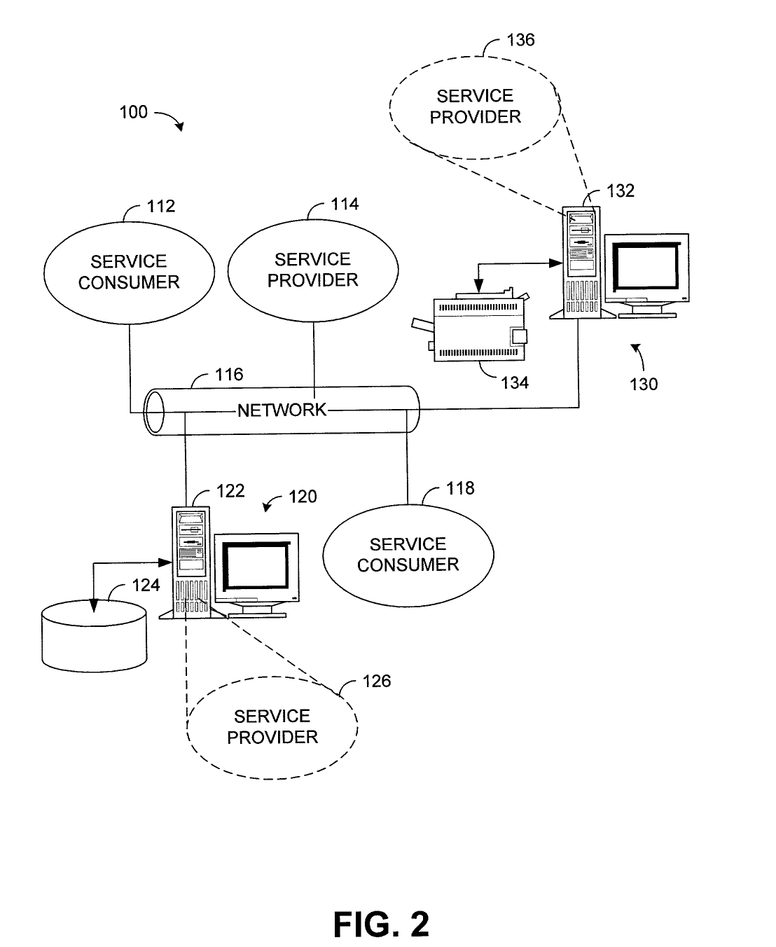

Reference is now made to FIG. 2, which is a diagram of an illustrative network environment over which a system 100, constructed in accordance with the present invention, may operate. In this regard, the system 100 is illustrated as having multiple service consumers (e.g., 112, 118), as well as multiple service providers (e.g., 114, 126,136), in communication across a network 116. The embodiments specifically described herein illustrate the network 116 as a local area network. However, as will be appreciated by persons skilled in the art, the concepts and teachings of the present invention are readily extensible to wide area networks, including the Internet. It will be further appreciated by persons skilled in the art, that IP routers are often configured to block Multicast broadcasts across LAN boundaries. Therefore, appropriate configuration changes to IP routers may be required to permit the invention to be utilized to span LAN boundaries. Since such details are not the subject of the present application, nor are they central to its understanding, they need not be described herein.

Certain hardware components, such as servers 120 and 130 are also illustrated. Server 120 is illustrated as a database server. The server includes a computer 122 in communication with a database or storage device 124. Of course, the storage device 124 may be a hard disk that is located internal to the computer 122, but has been depicted as a separate device in the drawing, purely for purposes of illustration. Having a resource, which may be demanded by other entities on the network 116, the server 120 includes a service provider 126, which manages the resource component. Likewise, server 130 is illustrated as a print server. The server includes a computer 132 in communication with a printer 134. Having a resource (i.e., the printer 134) which may be demanded by other entities on the network 116, the server 130 includes a service provider 136. Numerous additional types of service providers may be included within the scope and spirit of the present invention, and yet have not been specifically illustrated herein. As briefly discussed above, a service provider is merely an entity that provides a resource, service, interface, program segment, or other component to a service consumer, which requests the use of such a component.

In this regard to FIG. 2 has been provided merely for purposes of illustration, and should not be viewed as limiting upon the scope of the present invention.

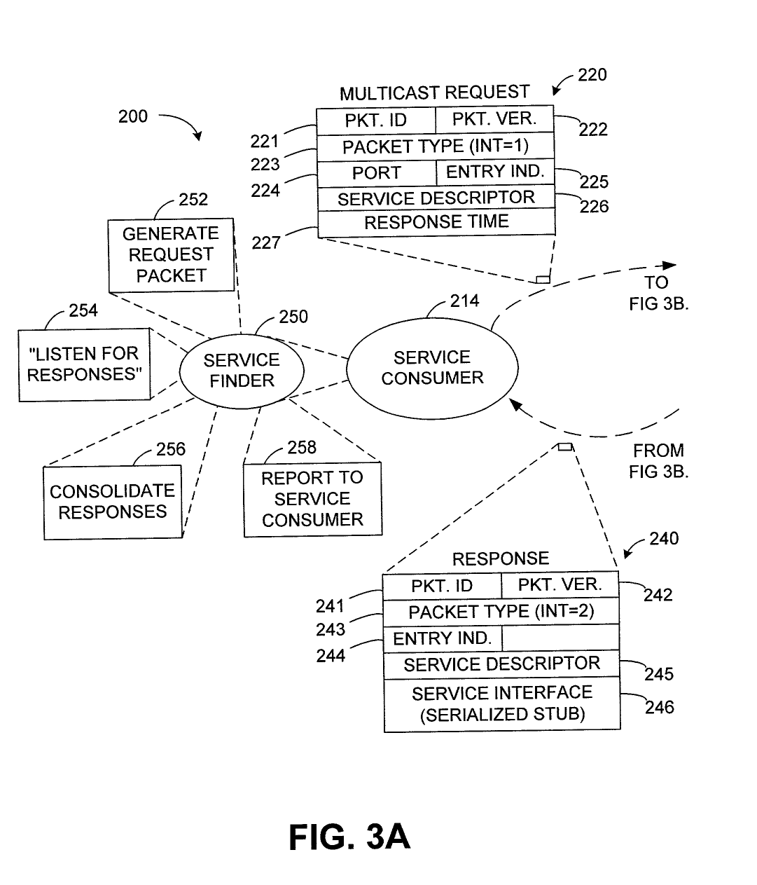

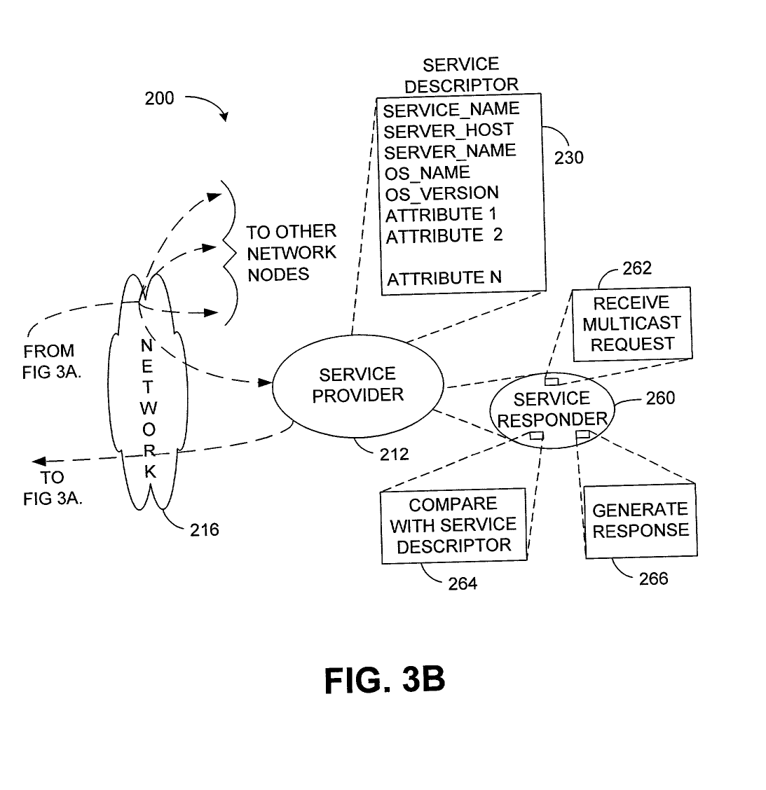

Reference is now made to FIGS. 3A and 3B, which collectively comprise a diagram illustrating the principal components of a system 200 constructed in accordance with the preferred embodiment of the invention. To simplify the drawing, only a single service provider 212 and a single service consumer 214 have been illustrated. In addition to the principal components of the preferred system 200, the drawing of FIGS. 3A and 3B is also useful in illustrating the method of a preferred embodiment as well. In this regard, the description set forth immediately below describes the principal methodology of a preferred embodiment. The various components of the system are described in the context and flow of the methodology.

An early step in the methodology is the generation by a service consumer 214 of a request for a component (e.g., service, interface, resource, code segment, etc.) to be supplied by a service provider 212. Depending upon the application being executed at the service consumer 214, the request may be generated automatically (e.g., under program control), or may be generated under the control and instruction of a user. For example, and as presented in the example above, a user using a word processing application and desiring to print a document may specify that the desired printer be a color laser, high-speed printer, capable of printing double sided pages and located in a particular building. In such a scenario, the request will be partially created under the direct control of the user.

In the preferred embodiment, the request is created in the form of a data packet 220, which is broadcast across the network 216 to all devices on the network. The structure and physical makeup of the data packet 220 may vary. However, a preferred data packet includes a packet ID 221, a packet version 222, a packet type 223, a port number 224, an entry index 225, and a service descriptor 226. In the preferred embodiment, the packet ID 221 is a short string that uniquely identifies the data packet. The packet version 222 is an integer number which may be used as, and if, later versions of the system are developed. The packet type 223 is preferably an integer that indicates whether the packet is a discovery packet (i.e., request), a response packet, an announcement packet, or some other type of packet that may be supported by the system 200. The port number 224 identifies the port that the response should be directed to. The entry index 225 is an identifier of the handler that the response should be directed to. Finally, the service descriptor 226 is essentially a hash table of name/value pairs that define the various attributes, which are being sought by the service consumer 214. Additional information regarding the service descriptor 226 will be discussed below in connection with reference numeral 230.

In a preferred embodiment a “response time” field 227 may also be included as part of the request packet. This field preferably specifies a maximum time period for response. Service providers, upon receipt of a request packet, preferably generate a random delay period (up to the period set by the response time field) for delaying the response. This helps reduce congestion on the network when large numbers of responses are generated. Additional fields, not shown, may also be included within the request packet, including unused fields to support future expansion.

It will be appreciated that the message packet 220 depicted in the drawing should be viewed merely as illustrative, and not limiting upon the invention. In this regard, a system constructed in accordance with the inventive teachings may generate or utilize request packets having a variety of different forms and structures. What is significant for purposes of the preferred embodiment, however, is that the request packet defines one or more attributes of a component being requested by the service consumer 214.

As mentioned above, in the preferred embodiment, the service consumer 214 broadcasts the request packet 220 to all devices on the network 216. Although there are a variety of ways that such a message broadcast may be implemented, in the preferred embodiment, a multicast protocol is utilized. Preferably, request packets 220 are broadcast from a service consumer using UDP multicast over IP networks.

In this regard, and as is known, in large scale networks, it is sometimes desirable to quickly broadcast short messages containing relatively few packets to the network and to ensure that every device on the network receives the message with either an absolute certainty or with a very high probability. A sending device can send the message to a number of receiving devices. Inasmuch as it is possible to reliably transmit relatively short messages, a large, loosely coupled network can have centralized control attributes similar to those characteristics of mainframe systems. One way to ensure reliability is to communicate with each and every receiving system using a connection based protocol, such as TCP over an IP network. In a connection based protocol one device forms a connection to another device, transacts all communication with that device, and then terminates the connection. If communication with multiple devices is desired, a connection is formed with each system, in turn. The overhead associated with creating and managing a connection between a sending system and a number of receiving systems is prohibitively expensive when there are a large number of receiving systems.

In order to reduce the overhead associated with connection based protocols, connectionless protocols, such as UDP over an IP network, have been developed. Connectionless protocols typically rely on a broadcast or “multicast” model where a single message is broadcast to a multiple receiving devices without forming a connection with the individual systems. This approach eliminates the overhead associated with forming connections with each device, but generally suffers from the inability to guarantee receipt of messages to all devices. For IP networks, multicast is unreliable by design in order to reduce overhead of sending packets to multiple destinations.

Other messaging protocols have been developed to address the problem of high reliability in the context of large messages consisting of hundred of thousands or millions of packets, but not for short messages of relatively fewer packets. Such protocols send data from a sending system to multiple receiving devices connected in an IP network using IP multicast that reduces sending overhead.

Again, in the context of the present invention, any of these methodologies could be utilized. However, it is further appreciated that reliable delivery to each and every device is not essential, as no given device must reply. Preferably, request packets 220 are broadcast from a service consumer using UDP multicast over IP networks.

In keeping with the description of FIGS. 3A and 3B, when a given service provider 212 receives a request packet 220, it compares the attributes defined in the received packet with attributes of the various components that the service provider 212 has, which may be made available to other devices on the network 216. In this regard, the service provider 212 may include a service descriptor for each and every component that it has, which may be made available to other devices on the network 216. Reference numeral 230 illustrates one such service descriptor. As previously mentioned, a service descriptor is essentially a hash table that includes name/value pairs that may be used to specify various attributes. In the illustrated service descriptor, items like service name, server host, server name, OS name, and OS version may be included in the service descriptor 230. In addition, a plurality of attributes may be defined or specified within the service descriptor 230 as well. Again, there are a countless number and types of attributes, which may be defined within various service descriptors, depending upon the application. Such attributes will be appreciated by persons skilled in the art, based upon the context of a given application. Therefore, an exhaustive listing of attributes need not be set out herein. Once a request packet 220 is received by a service provider 212, the service provider 212 compares the attributes specified in the service descriptor 226 of the received packet with the attributes specified in the service descriptors (e.g., 230) of the various components of the service provider 212. If all of the attributes specified in the service descriptor 226 of the request packet are contained within a service descriptor 230 of a component of the service provider 212, then the service provider 212 generates a response indicating that it can provide the specified component to the service consumer 214. Consistent with the invention, the service provider 212 may be configured to generate a similar response even though all attributes specified by the service descriptor 226 of the request may not be contained within a single service descriptor 230 of the service provider 212. Instead, the service provider 212 may be configured to generate a responsive message if, for example, a certain percentage of attributes specified in the service descriptor 226 of the request are found in a single service descriptor 230 within the service provider 212. Consistent with the invention, other varying algorithms may be utilized in determining when a service provider 212 is to generate a responsive message to communicate back to the service consumer 214.

In keeping with the method of the preferred embodiment, if the service provider 212 has determined that an appropriate “match” has been found (e.g., a sufficient number of attributes specified within the service descriptor 226 of the request are found within a service descriptor 230 of the service provider 212), then a responsive message packet 240 is generated by the such provider 212. Unlike the message packet 220, in the preferred embodiment, the response packet 240 is not broadcast to all devices on the network 216. Instead, it is communicated only to the requesting service consumer 214. In this regard, the response may be sent via a unicast message. However, consistent with the invention, the response may be sent in a variety of ways, including through a reliable response using TCP.

In accordance with the invention, the response packet 240 may be implemented in a variety of forms or structures. In a preferred embodiment, however, a response packet includes a packet ID 241, a packet version 242 a packet type 243, an entry index 244, a service descriptor 245, and a service interface 246. Most of these elements were described in connection with the request packet 220, and need not be described again. However, it is significant to note that the service descriptor 245 may be a duplicate of the service descriptor 230, which was deemed to be a match to the service descriptor 226. By sending the service descriptor 230 as a part of the response packet 240, the requesting service consumer 214 may make the ultimate determination as to whether the service descriptor 230 is an appropriate “match” for the component requested by the service consumer 214. In this regard, if the service descriptor 226 specified five attributes, and the service descriptor 230 contained only three of those attributes, the service provider 212 may deem a “match” to have been found. However, the service consumer 214 may not deem it to be a match, and may discard the response 240.

The response packet 240 also includes a service interface (a serialized stub) 246. In the preferred embodiment, this service interface 246 is implemented as a segment of Java code, which provides the code that is necessary for interfacing with the requested component of the service provider 212. Advantageously, this eliminates the need to pre-configure the service consumer 214 with a driver for the requested component. In addition, and although not explicitly illustrated, the response may also include an identification of the network address or location of the service provider. Consistent with the invention, however, this “stub” may be provided in any of a number of ways. In this regard, in a preferred embodiment, the stub need only provide a consumer with sufficient information to establish a connection with and utilize the services of the service provider. In some instances, this information may merely include an IP address, a port number, and methods that may be involved.

It will be appreciated that, for any given request broadcast by a service consumer 214, a plurality of responses may be received. The service consumer 214, therefore, includes the functional capability for handling such a plurality of responses. This functional capability may include discarding excessive responses, imposing a “timeout” period for receiving responses, and other handling issues.

After receive the response(s), the service consumer 214 may thereafter communicate directly with the service provider 212 to coordinate the cooperative use of the component supplied by the service provider. Again, this type of detail may be implemented in a variety of ways, and will be largely within the discretion of the programmer for the particular application.

In the illustrated embodiment, the service consumer 214 includes a service finder 250 that is responsible for generating a request, listening for responses, consolidating responses, reporting responses to the service consumer, etc. In one embodiment, the service finder 250 may be a separate process running under the service consumer. In the preferred embodiment, however, the service finder 250 is an instance having separate threads for execution. As illustrated, the service finder 250 includes a segment 252 for generating a request packet. This segment 252 is responsible for specifying a service descriptor, specifying at least one attribute, to be included in the request packet. The service finder 250 also includes a segment 254 that is responsible for “listening” for responses, after the request packet is broadcast over the network 216. The service finder 250 also includes a segment 256 for receiving and consolidating responses that are received. This segment 256 may impose a “timeout” period, during which it “listens” for responses. The responses are then consolidated into a vector, which may be passed to the service consumer 214. The service finder 250 includes a further segment 258, which reports benefactor of responses to the service consumer 214.

Like the service consumer 214, the service provider 212 preferably includes a mechanism for handling the reception of requests and the generation of responses. In the illustrated embodiment, this is handled by the service responder 260. Like the service finder 250, the service responder 260 may be a separate process. However, in the preferred embodiment, the service responder 260 is an instance having separate threads for execution. Among other functions, the service responder 260 includes a segment 262 for receiving multicast requests. The service responder 260 also includes a segment 264 for comparing the service descriptor of the received requests with a service descriptor 230 of each component of the service provider 212. The service responder 260 includes a further segment 266 for generating response packets that are communicated to the requesting service consumer 214.

It should be appreciated from the foregoing that the present invention provides a novel system and method for accessing remote software components in a computer network environment. The method of a preferred embodiment includes the steps of generating a request for a component having a least one specified attribute, broadcasting the request across the network, receiving the request at a service provider, comparing the at least one specified attribute of the received request with component attributes of the service provider, and communicating a response to the requesting service consumer. It should be further appreciated that the system and method of the preferred embodiment overcomes various shortcomings and disadvantages of prior art systems. Most notably, the system of the preferred embodiment eliminates the need for a centralized broker or a centralized directory service. Consequently, the elimination of this centralized item improves the fault tolerance of the system by avoiding the single point of failure injected by such a centralized component.

The foregoing description has been presented for purposes of illustration and description. It is not intended to be exhaustive or to limit the invention to the precise forms disclosed. Obvious modifications or variations are possible in light of the above teachings. The embodiment or embodiments discussed were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly and legally entitled.

What is claimed is:

1. In a distributed networked system having at least one service consumer and at least one service provider, a method for accessing a remote software component by a service consumer comprising:
generating a request for a component having a least one specified attribute;
broadcasting the request across the network;
receiving the request at a service provider;
comparing the at least one specified attribute of the received request with component attributes of the service provider; and
communicating a response to the requesting service consumer.

2. The method as defined in claim 1, wherein software component is selected from the group consisting of: a service, a resource, an interface, and a program segment.

3. The method as defined in claim 1, wherein the step of generating a request includes formulating a service descriptor, the service descriptor being an object that specifies the at least one specified attribute.

4. The method as defined in claim 1, wherein the step of broadcasting the request utilizes a multicast protocol for broadcasting the request across the network.

5. The method as defined in claim 1, wherein the network is a local area network.

6. The method as defined in claim 1, wherein the network is a wide area network.

7. The method as defined in claim 1, wherein the step of communicating a response utilizes a unicast protocol.

8. The method as defined in claim 1, further including the step of formulating a response by the service provider, which response includes an identification of a network location of the service provider.

9. The method as defined in claim 8, further including the step of directly requesting the component from the service provider by the service consumer, in response to the response received by the service consumer.

10. The method as defined in claim 8, wherein the step of formulating a response further includes associating with the response code for interfacing with the requested component, without requiring a driver to be separately installed on the service consumer.

11. The method as defined in claim 10, wherein the code for interfacing with the requested code is Java code in the form of a stub object.

12. A distributed networked system for accessing a remote software component comprising:
at least one service consumer;
at least one service provider;
means for generating a request at a service consumer for a component having a least one specified attribute;
means for broadcasting the request across the network;
means for receiving the request at a service provider;
means for comparing the at least one specified attribute of the received request with component attributes of the service provider; and
means for communicating a response to the requesting service consumer.

13. The system as defined in claim 12, further including means for generating the response.

14. The system as defined in claim 13, wherein the means for generating the response is configured to include within the response a mechanism for identifying a network location for the component.

15. The system as defined in claim 13, wherein the means for generating the response is configured to include within the response a code segment that allows the service consumer that generated the request to interface with the component without having a separately installed driver on the service consumer.

16. The system as defined in claim 15, wherein the code segment includes Java code in the form of a stub object.

17. The system as defined in claim 13, wherein the means for broadcasting the request includes a multicast protocol.

18. The system as defined in claim 13, wherein the means for generating a request includes a service finder.

19. The system as defined in claim 13, further including means for consolidating responses and providing the consolidated responses to the service consumer.

20. A distributed networked system for accessing a remote software component comprising:
at least one service consumer;
at least one service provider;
a mechanism configured to generate a request at a service consumer for a component having a least one specified attribute;
a mechanism configured to broadcast the request across the network;
a mechanism configured to receive the request at a service provider;
a mechanism configured to compare the at least one specified attribute of the received request with component attributes of the service provider; and
a mechanism configured to communicate a response to the requesting service consumer.
